(19) United States
(12) Patent Application Publication
(10) Pub. No.: US 2012/0327130 A1
(43) Pub. Date: Dec. 27, 2012

(54) FLOATING VIRTUAL PLASMA DISPLAY APPARATUS

(75) Inventor: CHIH-HSIUNG LIN, New Taipei City (TW)

(73) Assignee: Era Optoelectronics Inc., New Taipei City (TW)

(21) Appl. No.: 13/244,457

(22) Filed: Sep. 24, 2011

(30) Foreign Application Priority Data
Jun. 24, 2011 (TW) 100122254

(51) Int. Cl. G09G 3/28; G09G 5/10; G02B 27/20

(52) U.S. Cl. 345/690; 362/259; 345/63

(57) ABSTRACT

A floating virtual plasma display apparatus includes a scanning mechanism, an optical focusing unit and a laser light source; a laser line is focused by the optical focusing unit, allowing air particles in the air around a focus of the optical focusing unit to be ionized into plasma to generate an ionized beam spot when the laser line is emitted from the laser light source; a floating virtual image is generated after the position of the beam spot is altered through the scanning of the scanning mechanism; the floating virtual image is allowed to display a variable virtual image like a floating moving screen by controlling the laser light source to emit bright, dark laser lines corresponding to an image.

### BACKGROUND OF THE INVENTION

1. Field of the Invention

The present invention relates to a display apparatus, and more particularly to a floating virtual display apparatus capable of being used as a screen.

2. Description of Related Art

Taiwan publishing patent NO. 200951771 discloses an apparatus with a virtue touch screen, including a screen, an optical mechanism, and a detection module, where the optical mechanism has at least one optical lens. The picture on the screen is formed into a corresponding virtual screen image in a space through the optical mechanism by means of optical imaging principle. The detection module is used to detect whether a user touches the virtual screen image or not, detect and analyze the position of a contact position with the virtual screen, and transfer the position to a contact position with the screen corresponding thereto and signal commands so that the user can operate the digital contents displayed on the virtue screen with a touch control mode, thereby achieving the effect of operating the screen substantially instead of touching it directly. The above-mentioned Taiwan published patent still need use a general screen to provide the images needed for the virtual screen, and a traditional screen cannot be omitted to reduce the cost.

Referring to FIG. 1, when a light beam emitted from a high-power laser light source 1 illuminates a general optical focusing unit 2, for example, a convex lens or Fresnel lens having a focusing function, air particles in the air around a focus are caused to ionize into plasma to yield a floating ionized beam spot 3. In addition, the optical focusing unit 2 may also be a concave lens, but the laser light, source must be positioned to illuminate the concave lens from the front of the concave lens, and the laser light beam is then allowed to focus at the focus.

Referring to FIG. 2, a Micro Electro Mechanical System (MEMS) scanning mechanism made by combining a MEMS 41 with a micro scanning mirror (MSM) 42 is now available in the market. When a light beam corresponding to a fixed or moving image is emitted from a light source 43 and then projected on the MSM 42, the MSM scans it from left to right and from top to down, and projects it to a projecting surface 40 such that a corresponding image can then be displayed. But, the MSM projector cannot project a floating moving image currently.

### SUMMARY OF THE INVENTION

To improve a conventional floating plasma display apparatus, the present invention is proposed.

The main object of the present invention is to provide a floating virtual plasma display apparatus, including a scanning mechanism, an optical focusing unit, and a laser light source; when a light beam emitted from a laser light source is focused by the optical focusing unit, air particles in the air around a focus are caused to ionize into plasma to yield a floating ionized beam spot; a floating virtual image is generated after the position of the ionized beam is altered through the scanning of the scanning mechanism.

Another object of the present invention is to provide a floating virtual plasma display apparatus, allowing a floating virtual image to display a variable virtual image like a floating moving screen by controlling a laser light source to emit bright, dark laser light beams corresponding to an image.

### BRIEF DESCRIPTION OF THE DRAWINGS

The present invention can be more fully understood by reference to the following description and accompanying drawings, in which:

FIG. 1 is a schematic view, showing that a conventional laser light source and optical focusing unit are used to generate a floating ionized beam spot;

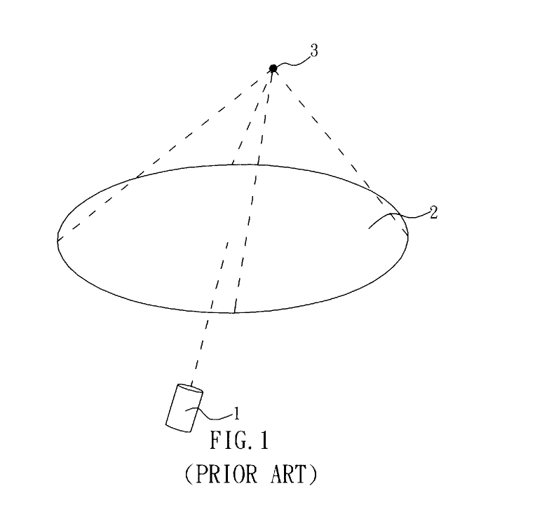

FIG. 2 is a schematic view of a conventional MSM projector, projecting an image;

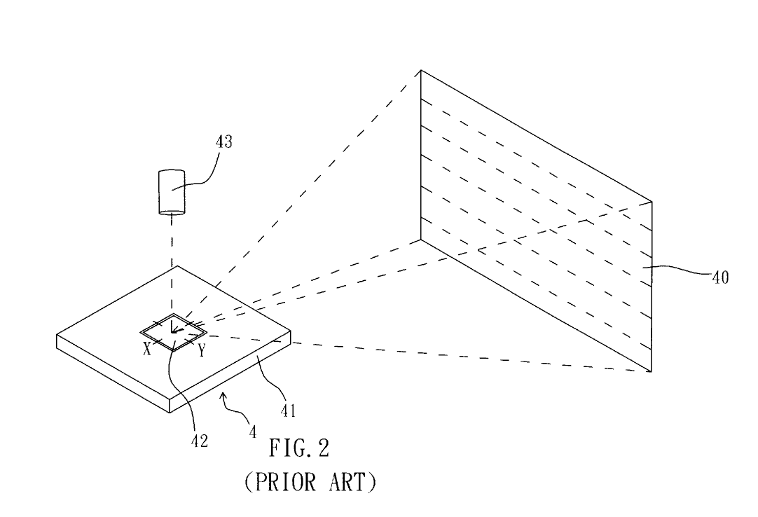

FIG. 3 is a schematic view of a floating virtual plasma display apparatus of a first preferred embodiment according to the present invention;

FIG. 4 is a schematic view of a floating virtual plasma display apparatus of a second preferred embodiment according to the present invention; and

FIG. 5 is a schematic view of a floating virtual plasma display apparatus of a third preferred embodiment according to the present invention.

### DETAILED DESCRIPTION OF THE PREFERRED EMBODIMENTS

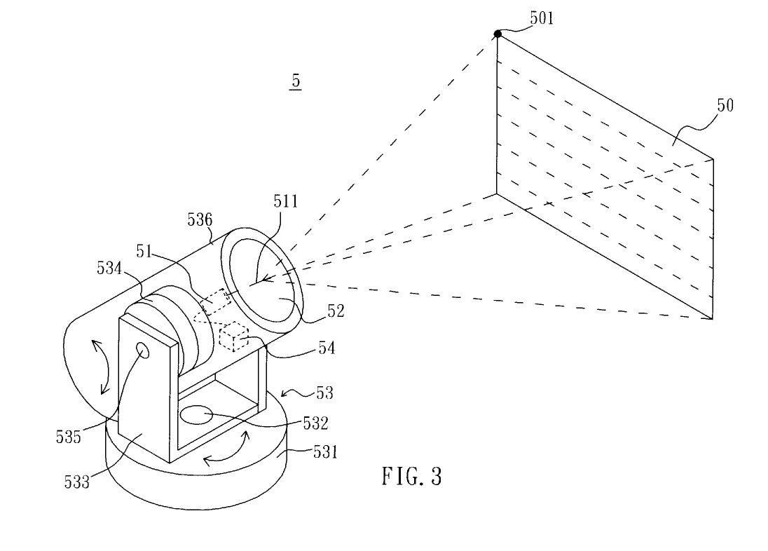

Referring to FIG. 3, a floating virtual plasma display apparatus 5 of a first preferred embodiment according to the present invention includes a high-power laser light source 51, an optical focusing unit 52, a scanning mechanism 53 and an image signal processing unit 54. The laser light source 51 is electrically connected to the image signal processing unit 54. The scanning mechanism 53 is a conventional structure and configured with a first motor 531, a first shaft (x-axis) 532, a first bracket 533, a second motor 534, a second shaft (Y-axis) 535 and a second bracket 536. The first bracket 533 is respectively coupled to the first shaft 532 and the second motor 534, and the second shaft 535 is coupled to the second bracket 536. The first motor 531 can drive the first shaft 532 to rotate, allowing the first bracket 533 to take the first shaft 532 as a rotating axis scanning from left to right repeatedly, and the second can drive the second shaft to rotate, allowing the second bracket 536 to take the second shaft 535 as a rotating axis scanning up-down repeatedly.

The laser light source 51, laser focusing unit 52 and image signal processing unit 54 are respectively coupled to the second bracket 536 of the scanning mechanism 53. The scanning way of the scanning mechanism 53 is first taking the first shaft 532 as a rotating center scanning from left to right, and then taking the second shaft 535 as a rotating center rotating down-up a small angle. Thereafter, the scanning mechanism 53 takes the first shaft 532 as a rotating center again rotating from right to left, and repeats the above-mentioned procedures scanning from left to right and up to down over and over again.

A laser line 511 is focused by the optical focusing unit 52, allowing air particles in the air around a focus to be ionized into plasma to generate an ionized beam spot 501 when the laser line 511 is emitted from the laser light source 51. A floating virtual image 50 is displayed to a human's vision through human persistence of vision after the position of the ionized beam spot 501 is altered through the scanning of the scanning mechanism 53 with a scanning speed of more than 24 times per second to the whole picture of the virtual image 50. The floating virtual image 50 is allowed to display a variable virtual image like a floating moving screen by controlling the laser light source 51 to emit different bright, dark laser lines corresponding to an image through the image signal processing unit 54.

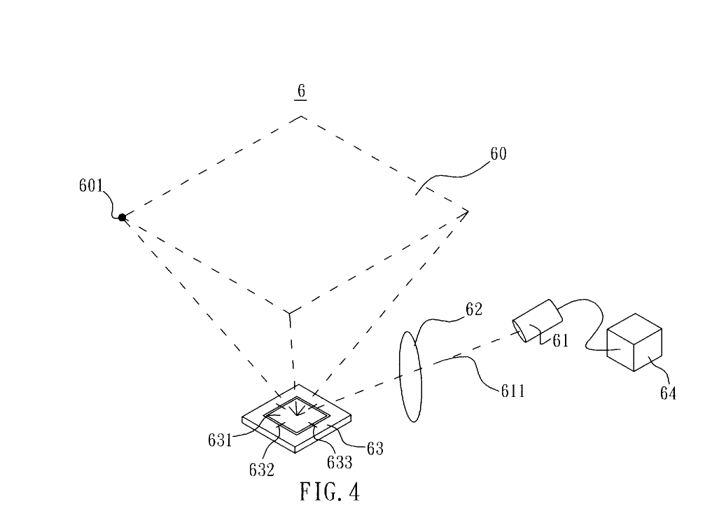

Referring to FIG. 4, a floating virtual plasma display apparatus 6 of a second preferred embodiment according to the present invention includes a high-power laser light source 61, an optical focusing unit 62, a scanning mechanism 63 and an image signal processing unit 64. The laser light source 61 is electrically connected to the image signal processing unit 64. The scanning mechanism 63 is installed with a scanning mirror 631, and the scanning way of the scanning mirror 631 is taking a first axis (X-axis) 632 as a rotating axis scanning from left to right repeatedly, and then taking a second axis (Y-axis) 633 as a rotating axis rotating down-up a small angle. Thereafter, the scanning mirror 631 repeats the above-mentioned procedures scanning from left to right and up to down over and over again.

A laser line 611 is focused by the optical focusing unit 62, allowing air particles in the air around a focus to be ionized into plasma to generate an ionized beam spot 601 when the laser line 611 is emitted from the laser light source 61. A floating virtual image 60 is displayed to a human's vision through human persistence of vision after the position of the ionized beam spot 601 is altered through the scanning of the scanning mechanism 63 with a scanning speed of more than 24 times per second to the whole picture of the virtual image 60.

In the present embodiment, the laser line 611 is emitted from the laser light source 61 is first focused by the optical focusing unit 62, projected to the scanning mirror 631, and further reflected by the scanning mirror 631 to generate the ionized beam spot 601. Thereafter, the position of the ionized beam spot 601 is altered by means of the scanning of the scanning mirror 631, thereby generating a floating virtual image 60. The floating virtual image 60 is allowed to display a variable virtual image like a floating moving screen by controlling the laser light source 61 to emit different bright, dark laser lines corresponding to an image through the image signal processing unit 64.

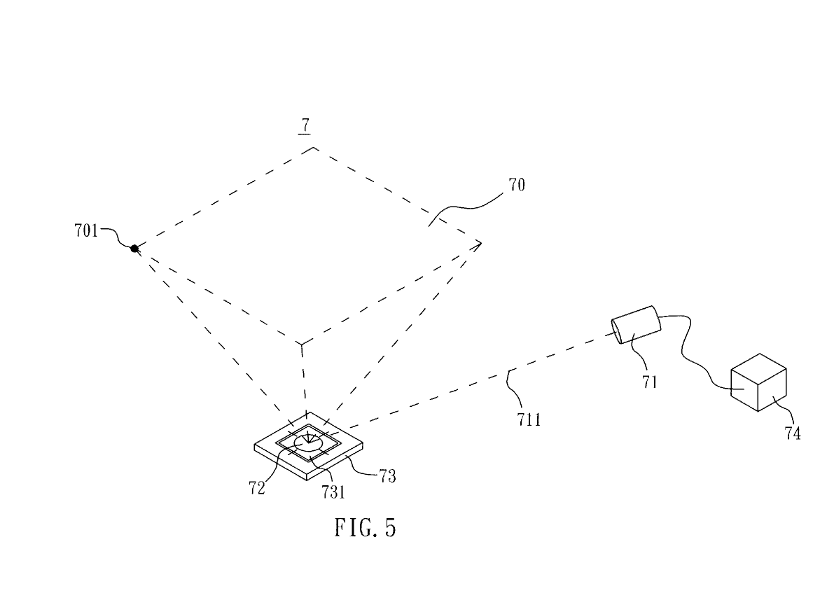

Referring to FIG. 5, a floating virtual plasma display apparatus 7 of a third preferred embodiment according to the present invention includes a high-power laser light source 71, an optical focusing unit 72, a scanning mechanism 73 and an image signal processing unit 74. The laser light source 71 is electrically connected to the image signal processing unit 74, and the scanning mechanism 73 is installed with a scanning unit 731. The optical focusing unit 72 of the present embodiment is coupled to the scanning unit 731, and may carry out a scanning similar to the scanning way of the scanning mirror in the second embodiment with the scanning unit 731.

A laser line 711 is focused by the optical focusing unit 72, allowing air particles in the air around a focus to be ionized into plasma to generate an ionized beam spot 701 when the laser line 711 is emitted from the laser light source 71. A floating virtual image 70 is displayed to a human's vision through human persistence of vision, after the position of the ionized beam spot 701 is altered through the scanning of the optical focusing unit 72 driven by the scanning mechanism 73 with a scanning speed of more than 24 times per second to the whole picture of the virtual image 70. The floating virtual image 70 is allowed to display a variable virtual image like a floating moving screen by controlling the laser light source 71 to emit different bright, dark laser lines corresponding to an image through the image signal processing unit 74.

The optical focusing unit 72 of the present embodiment may be a conventional concave lens, convex lens or Fresnel lens having a focusing function, and the scanning unit 731 may be the one such as the scanning mirror in the second embodiment.

When the optical focusing unit 72 is a concave lens, the light beam emitted from the light source 71 will be reflected and focused by the concave lens so as to generate an ionized beam spot 701, and meanwhile, scanned by the concave lens to generate a floating virtual image 70.

When the optical focusing unit 72 is a convex lens or Fresnel lens having a focusing function and the scanning unit 731 is a scanning mirror, the light beam 711 emitted from the light source 71 will be reflected by the scanning mirror, and then focused by the convex lens or Fresnel lens to generate an ionized beam spot 701, and meanwhile, scanned by the scanning mirror to generate a floating virtual image 70.

The optical focusing unit of the first and second embodiments of the present invention may be a conventional convex lens or Fresnel lens having a focusing function; the scanning mechanism of the second and third embodiments may be a conventional micro electro mechanical system (MEMS) scanning mechanism.

In the floating virtual plasma display apparatus of the present invention, air particles in the air around a focus of the optical focusing unit are ionized to generate an ionized beam spot after a laser line emitted from the laser light source is focused by the optical focusing unit; a floating virtual image like a floating virtual screen is generated after the position of the beam spot is altered through the scanning of the scanning mechanism; the floating virtual image is allowed to display a variable virtual image like a floating moving screen by controlling the laser light source to emit bright, dark laser lines corresponding to an image such that a traditional screen can be omitted thereby reducing the cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A floating virtual plasma display apparatus, comprising:
an optical focusing unit;
a laser light source; and
a scanning mechanism;
wherein, a laser line is focused by said optical focusing unit, allowing air particles in air around a focus of said optical focusing unit to be ionized into plasma to generate an ionized beam spot when said laser line is emitted from said laser light source; a floating virtual image is generated after a position of said beam spot is altered through a scanning of said scanning mechanism.

2. The floating virtual plasma display apparatus according to claim 1, wherein said scanning mechanism is configured with a first motor, a first shaft, a first bracket, a second motor, a second shaft and a second bracket; said first bracket is respectively coupled to said first shaft and said second motor, and said second shaft is coupled to said second bracket; when said first motor drives said first shaft to rotate, said first bracket is allowed to take said first shaft as a rotating axis scanning from left to right repeatedly; when said second motor drives said second shaft to rotate, said second bracket is allowed to take said second shaft as a rotating axis scanning up-down repeatedly; said laser light source, said optical focusing unit and said image signal processing unit are respectively coupled to said second bracket.

3. The floating virtual plasma display apparatus according to claim 2, wherein said optical focusing unit is one selected from a convex lens and a Fresnel lens having a focusing function.

4. The floating virtual plasma display apparatus according to claim 1, wherein said scanning mechanism is configured with, a scanning mirror; a laser line emitted from said laser light source is first focused by said optical focusing unit, projected to said scanning mirror, and then reflected by said scanning mirror to generate said ionized beam spot; a position of said ionized beam spot is altered through a scanning of said scanning mirror to generate said floating virtual image.

5. The floating virtual plasma display apparatus according to claim 4, wherein said scanning mechanism is a micro electro mechanical system scanning mechanism, and said optical focusing unit is one selected from a convex lens and a Fresnel lens having a focusing function.

6. The floating virtual plasma display apparatus according to claim 1, wherein said scanning mechanism is configured with a scanning unit, and said optical focusing unit is coupled to said scanning unit and carries out scanning with said scanning unit.

7. The floating virtual plasma display apparatus according to claim 6, wherein said optical focusing unit is a concave lens; a light beam is reflected and focused by said concave lens to generate said ionized beam spot, meanwhile, scanned by said concave lens to generate said floating virtual image when said light beam is emitted from said light source.

8. The floating virtual plasma display apparatus according to claim 7, wherein said scanning mechanism is a micro electro mechanical system scanning mechanism.

9. The floating virtual plasma display apparatus according to claim 6, wherein said optical focusing unit is one selected from a convex lens and a Fresnel lens having a focusing function; said scanning unit is a scanning mirror; a light beam is reflected by said scanning mirror, and then focused by said convex lens or said Fresnel lens having a focusing function to generate said ionized beam spot, meanwhile, scanned by said scanning mirror to generate said floating virtual image when said light beam is emitted from said light source; said scanning mechanism is a micro electro mechanical system scanning mechanism.

10. The floating virtual plasma display apparatus according to any one of claim 1, further comprising an image signal processing unit; said laser light source being electrically coupled to said image signal processing unit; said floating virtual image being allowed to display a variable virtual image by controlling said laser light source to emit bright, dark laser lines corresponding to an image through said image signal processing unit.

11. The floating virtual plasma display apparatus according to any one of claim 2, further comprising an image signal processing unit; said laser light source being electrically coupled to said image signal processing unit; said floating virtual image being allowed to display a variable virtual image by controlling said laser light source to emit bright, dark laser lines corresponding to an image through said image signal processing unit.

12. The floating virtual plasma display apparatus according to any one of claim 3, further comprising an image signal processing unit; said laser light source being electrically coupled to said image signal processing unit; said floating virtual image being allowed to display a variable virtual image by controlling said laser light source to emit bright, dark laser lines corresponding to an image through said image signal processing unit.

13. The floating virtual plasma display apparatus according to any one of claim 4, further comprising an image signal processing unit; said laser light, source being electrically coupled to said image signal processing unit; said floating virtual image being allowed to display a variable virtual image by controlling said laser light source to emit bright, dark laser lines corresponding to an image through said image signal processing unit.

14. The floating virtual plasma display apparatus according to any one of claim 5, further comprising an image signal processing unit; said laser light source being electrically coupled to said image signal processing unit; said floating virtual image being allowed to display a variable virtual image by controlling said laser light source to emit bright, dark laser lines corresponding to an image through said image signal processing unit.

15. The floating virtual plasma display apparatus according to any one of claim 6, further comprising an image signal processing unit; said laser light source being electrically coupled to said image signal processing unit; said floating virtual image being allowed to display a variable virtual image by controlling said laser light to an image through said image signal processing unit.

16. The floating virtual plasma display apparatus according to any one of claim 7, further comprising an image signal processing unit; said laser light source being electrically coupled to said image signal processing unit; said floating virtual image being allowed to display a variable virtual image by controlling said laser light source to emit bright, dark laser lines corresponding to an image through said image signal processing unit.

17. The floating virtual plasma display apparatus according to any one of claim 8, further comprising an image signal processing unit; said laser light source being electrically coupled to said image signal processing unit; said floating virtual image being allowed to display a variable virtual image by controlling said laser light source to emit bright, dark laser lines corresponding to an image through said image signal processing unit.

18. The floating virtual plasma display apparatus according to any one of claim 9, further comprising an image signal processing unit; said laser light source being electrically coupled to said image signal processing unit; said floating virtual image being allowed to display a variable virtual image by controlling said laser light source to emit bright, dark laser lines corresponding to an image through said image signal processing unit.
